(19) United States
(12) Patent Application Publication
(10) Pub. No.: US 2016/0001878 A1
(43) Pub. Date: Jan. 7, 2016

(54) EASY LANDING DRONE

(71) Applicant: NES&TEC CO.,LTD., Yuseong-gu Daejeon (KR)

(72) Inventor: Ki-Seong LEE, Daejeon (KR)

(21) Appl. No.: 14/768,476

(22) PCT Filed: Feb. 6, 2014
(86) PCT No.: PCT/KR2014/001001

§ 371 Date: Aug. 18, 2015

(30) Foreign Application Priority Data
Feb. 25, 2013 (KR) 10-2013-0020070

(51) Int. Cl. B64C 27/28; B64C 39/02

(52) U.S. Cl. CPC B64C 27/28; B64C 39/024; B64C 2201/108

(57) ABSTRACT

Disclosed is an easy landing drone. The drone includes: a propeller changing direction; a propeller tower supporting the propeller; a body connected to the propeller tower; a main wing arranged left-right symmetrically with respect to a horizontal axis of the body and having a pair of holes around a center of gravity of the body; a pair of auxiliary wings disposed in the pair of holes, respectively; and an actuator connected to a base shaft fixed to the main wing through the pair of auxiliary wings and controlling angles of the pair of auxiliary wings.

### TECHNICAL FIELD

The present invention relates to an easy landing drone.

### BACKGROUND ART

Drones are classified, in accordance with the fixing type of wings, into a fixed wing type with wings fixed to the body of the aircraft and a rotary wing type with wings rotating about the central shaft of the body of the aircraft.

A fixed wing type drone operates faster with higher fuel efficiency than a rotary wing type drone, but it requires a wide area such as a runway for takeoff and landing.

Accordingly, parachutes or an airbags are recently used to land drones in a small area without a runway.

FIG. 1 shows a drone with a parachute of the related art.

As shown in FIG. 1, when the drone lands with the parachute deployed, it is possible to safely recover the drone safe by reducing landing shock, but the parachute cannot normally operate under poor weather conditions, for example, due to rain, snow, and wind, so the drone may land out of the target landing point.

Further, when a parachute is released from the body of the aircraft by a spring or an explosive, the parachute may not be normally deployed, so the drone that is landing may fall to the ground before deployment of the parachute.

Further, the method of mounting an airbag on the bottom of the body of a drone absorbs less shock than the way of using a parachute, so the drone that is landing may possibly be damaged. However, when the structure of the drone is reinforced to supplement this problem, the flight ability of the drone may be reduced due to an increase in weight of the drone.

### DISCLOSURE

### Technical Problem

Accordingly, the present invention has been made keeping in mind the above problems occurring in the related art, and the present invention is intended to propose an easy landing drone that can easily land by turning upward a propeller arranged in the flight direction when it lands.

Further, the present invention provides an easy landing drone that can easily land by opening holes in main wings by controlling auxiliary wings in landing.

### Technical Solution

In order to achieve the above object, according to one aspect of the present invention, there is provided an easy landing drone that includes: a propeller changing direction; a propeller tower supporting the propeller; a body connected to the propeller tower; a main wing arranged left-right symmetrically with respect to a horizontal axis of the body and having a pair of holes around the center of gravity of the body; a pair of auxiliary wings disposed in the pair of holes, respectively; and an actuator connected to a base shaft fixed to the main wing through the pair of auxiliary wings and controlling angles of the pair of auxiliary wings, in which the propeller looks forward in flight and looks upward in landing.

The propeller may include a plurality of blades converting engine torque into thrust, a housing combined with the blades, and a turning neck connecting the housing and the propeller tower to each other, and the thrust may be 40 to 60% of weight of the drone.

In the propeller, the blades and the housing may look forward when the drone is flying, and the blades and the housing may be turned upward by the turning neck when the drone is landing.

The turning neck may include one or more of a gear box, a servo motor, and a step motor.

The drone may further include: a receiving unit receiving a flight control signal including an instruction to control the auxiliary wings; a sensing unit sensing current positions of the auxiliary wings; a comparing unit comparing a current position value of the auxiliary wings with a control instruction value of the flight control signal; a driving value creating unit creating an output value for driving the actuator in accordance with a result of the comparing; and a driving unit driving the actuator in accordance with the output value.

The actuator may include a first actuator and a second actuator, the pair of auxiliary wings may include a first auxiliary wing and a second auxiliary wing, the angle of the first auxiliary wing may be controlled by the first actuator, the angle of the second auxiliary wing may be controlled by the second actuator, and the propeller may look forward in flight and looks upward in landing.

### Advantageous Effects

According to an embodiment of the present invention, when the drone lands, the descending speed is controlled by turning upward the propeller looking forward, so it is possible to safely land the drone without a parachute or an airbag.

Further, since the holes of the main wing are opened so that the air stream from the propeller flows downward by changing the angles of the auxiliary wings, anti-torque due to rotational reaction of the propeller is offset and the yaw axis is controlled, so it is possible to control balance of the drone without a specific balancing device. Further, since a small propeller driving motor for landing is used, the weight of the drone can be reduced.

### DESCRIPTION OF DRAWINGS

FIG. 1 shows a drone with a parachute of the related art;

FIG. 2 shows a drone according to an embodiment of the present invention;

FIG. 3 shows the propeller of the drone that is landing, according to an embodiment of the present invention;

FIG. 4 shows the drone that is landing, according to an embodiment of the present invention;

FIG. 5 shows the configuration of the auxiliary wings of the drone according to a first embodiment of the present invention;

FIG. 6 shows the angle of an auxiliary wing of the drone according to an embodiment of the present invention;

FIG. 7 shows the configuration of auxiliary wings of the drone according to a second embodiment of the present invention; and

FIG. 8 shows a drone with small-sized auxiliary wings according to an embodiment of the present invention.

### DESCRIPTION OF THE REFERENCE NUMERALS IN THE DRAWINGS

| | |
|---|---|
| 100: propeller | 110: blade |
| 120: housing | 130: turning neck |
| 200: propeller tower | 300: body |
| 400: main wing | 410: hole |
| 500: auxiliary wing | 510: baseshaft |
| 520: actuator | 600: shock-absorbing part |
| 700: tail wing | |

### BEST MODE

Embodiments of the present invention will be described hereafter in detail with reference to the accompanying drawings. In the accompanying drawings, components not related to the description will be omitted in order to clearly describe the present invention, and like reference numerals will be used to describe like components throughout the present specification.

The case in which it is represented that a part is “on another part” is intended to include not only the case in which the part is directly on another part, but the case in which another part is between the two parts. However, when it is represented that a part is directly on another part, it means that there is no part between the two parts.

Hereinafter, the present invention will be described more fully with reference to the accompanying drawings for those skilled in the art to easily implement the present invention.

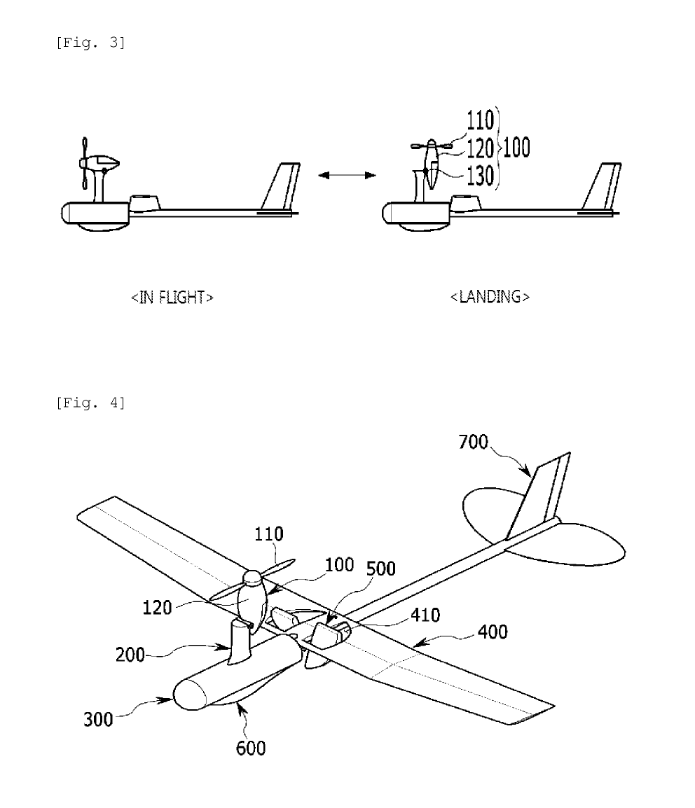

FIG. 2 shows a drone according to an embodiment of the present invention.

The drone shown in FIG. 2 includes a propeller 100, a propeller tower 200, a body 300, a main wing 400, and auxiliary wings 500.

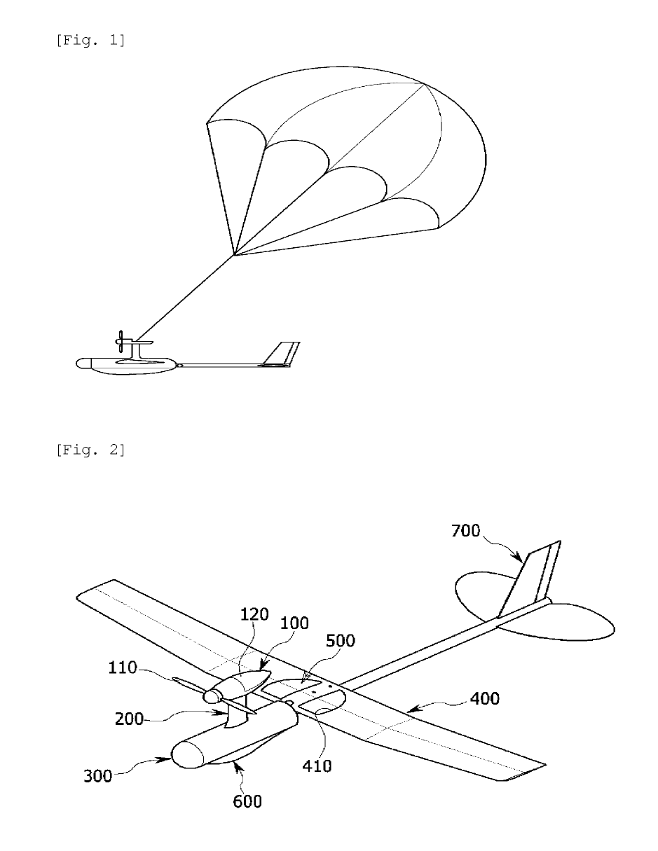

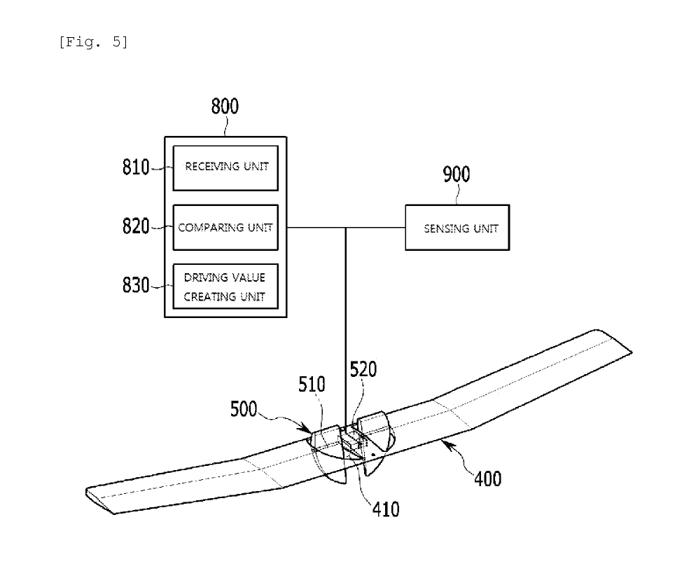

The propeller 100 provides the drone with thrust and may include a plurality of blades 110 converting engine torque into thrust, a housing 120 combined with the blades 110, and a turning neck 130 (not shown in FIG. 1) disposed at an end of the housing 120 and turning the housing 120. The number of the blades 110 may be two or four and the drone shown in FIG. 2 has two blades. A motor (not shown) for driving the blades 110 is provided and generates thrust smaller than the weight of the drone and the thrust may be about 40 to 60% of the weight of the drone. The blades 110 and the housing 120 can be turned with respect to the propeller tower 200 by the turning neck 130 (not shown in FIG. 1) in accordance with the flight state of the drone and this operation will be described in detail with reference to FIGS. 3 and 4.

The propeller tower 200 connects and supports the propeller 100 and the body 300 and may be disposed under the propeller 100 at the center of gravity of the drone. A driving unit for supplying a driving force to the propeller 100, a battery, fuel, and a fuel pump may be disposed in the propeller tower 200.

The body 300 supports the propeller tower 200 or keeps small freight, an unmanned camera, an engine, and a landing gear etc., and it may be formed in a streamline shape to minimize air resistance and maximize a receiving space. However, the shape of the body 300 is not limited to a streamline shape and may be formed in various shapes such as a stretched shape and a ring shape, depending on the use of the drone.

The main wing 400 generates lift and may be formed left-right symmetrically with respect to the body 300. The main wing 400 has holes 410 for receiving the auxiliary wings 500 and the holes 410 may be positioned around the center of gravity of the main wing 400. The shapes of the holes 410 are not limited and the holes 410 can be formed in any shapes unless they come out of the center of gravity of the main wing 400.

The auxiliary wings 500 generate lift in cooperation with the main wing 400 when the drone is flying, and they open the holes 410 in the main wing 400 by changing their angle when the drone is landing. The auxiliary wings 500 are symmetrically arranged in a pair at the left and right from the center of gravity of the main wing 400 and inserted in the holes 410 formed around the center of gravity of the main wing 400. Although the auxiliary wings 500 and the holes 410 shown in FIG. 2 have the same shape, they are not limited thereto and may be formed in various shapes such as a circle, a triangle, and a rectangle partially occupying the holes.

Other than the propeller 100, the propeller tower 200, the body 300, the main wing 400, and the auxiliary wings 500, the drone shown in FIG. 2 may further include a shock-absorbing part 600 for attenuating shock from the ground in landing and a tail wing 700 for maintaining balance and controlling direction of the drone. The tail wing 700 may be composed of a plurality of vertical stabilizers or horizontal stabilizers or a combination of a vertical stabilizer and horizontal stabilizers.

Although the main wing 400 and the auxiliary wings 500 are disposed behind the propeller tower 200 in the drone shown in FIG. 2, the main wing and the auxiliary wings may be disposed ahead of the propeller tower or the propeller tower may be disposed on the main wing and the auxiliary wings, depending on the shape or the center of gravity of the body of the drone.

FIG. 3 shows the propeller of the drone that is landing, according to an embodiment of the present invention.

As shown in FIG. 3, the propeller 100 of the drone locks forward in flight. When the drone starts landing while flying in response to a flight control signal from a remote area or a flight control algorithm, the housing 120 and the blades 110 are turned upward by the turning neck 130. The turning neck 120 is positioned at the joint of the housing 120 and propeller tower 200 and can control the rotational angle of the housing 120 using a gear box, a servo motor, and a step motor.

If the drone that is landing receives a flight control signal including an instruction to keep flying, the propeller 100 of the drone is controlled back to look forward in response to the flight control signal.

FIG. 4 shows the drone that is landing, according to an embodiment of the present invention.

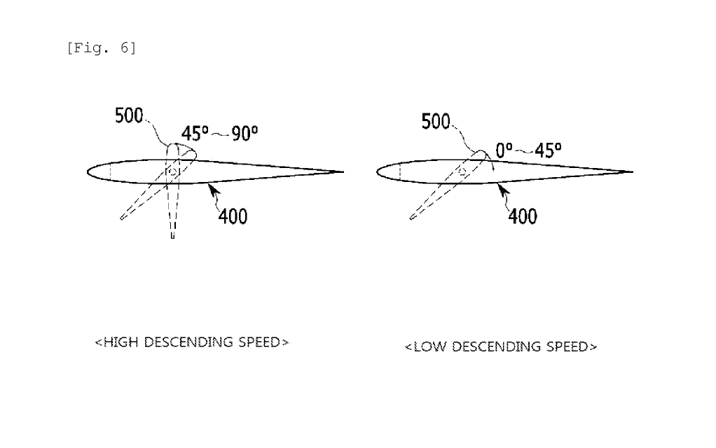

In the drone shown in FIG. 4, the auxiliary wings 500 are disposed behind the propeller tower 200, so when the propeller 100 turned upward and ready to land starts operating, the angles of the auxiliary wings 500 are controlled. As the angles of the auxiliary wings 500 are changed, the holes 410 of the main wing are opened and the air stream from the propeller flows down through the open holes 410. The open areas of the holes 410 can be controlled by the angles of the auxiliary wings 500, so it is possible to offset propeller anti-torque or control the yaw axis and direction angle of the drone. A method of controlling the auxiliary wings is described in detail with reference to FIG. 5.

FIG. 5 shows the configuration of the auxiliary wings of the drone according to a first embodiment of the present invention.

As shown in FIG. 5, the auxiliary wings 500 of the drone can be controlled by an actuator 520 connected to a base shaft 510 fixed to the main wing 400 through the auxiliary wings 500. The actuator 520 can be controlled by a control unit 800. When a flight control signal including an instruction to control the auxiliary wings from a remote area is received by a receiving unit 810, a sensing unit 900 connected to the actuator 520 senses the current positions of the auxiliary wings 500. The flight control signal including an instruction to control the auxiliary wings may be transmitted through a predetermined flight control algorithm. Thereafter, a comparing unit 820 compares the value according to the instruction to control the auxiliary wings with the current position value of the auxiliary wings, a driving value creating unit 830 creates a driving value for the actuator in accordance with the compared result, and the actuator 520 changes the angles of the auxiliary wings 500 in accordance with the driving value. Accordingly, it is possible to control the descending speed of the drone in landing by controlling the amount of air stream flowing down through the holes 410 from the propeller.

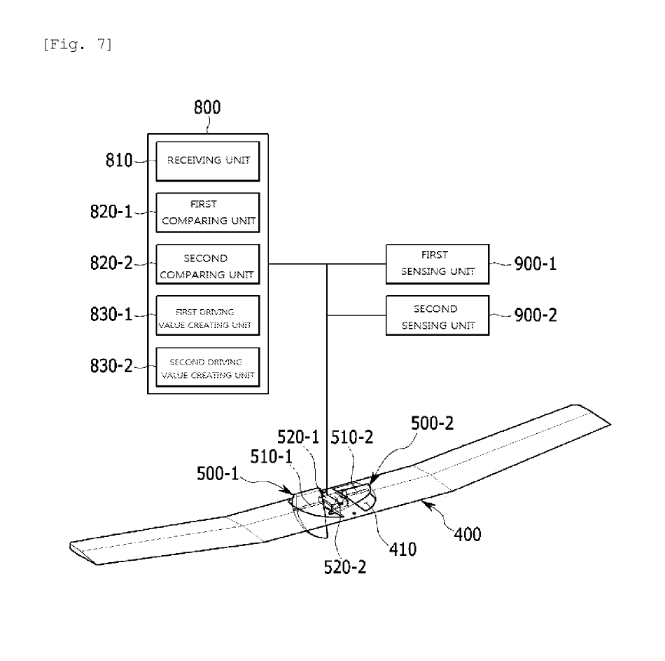

FIG. 6 shows the angle of an auxiliary wing of the drone according to an embodiment of the present invention.

As shown in FIG. 6, for example, when the drone is ready to land in flight, the angle of the auxiliary wing 500 from the top of the main wing 400 is controlled in the range of about 45°˜90°, so the open area of the hole 410 is increased and the descending speed is also increased. Thereafter, when the drone reaches a predetermined elevation from the ground, the angle of the auxiliary wing 500 inclined with respect to the top of the main wing 400 is controlled in the range of about 0°˜45° from the base shaft, so the open area of the hole 410 is decreased and the descending speed is also decreased, and accordingly, the drone can safely land on the ground.

In this process, a pair of auxiliary wings may be separately controlled by a first actuator and a second actuator.

FIG. 7 shows the configuration of auxiliary wings of the drone according to a second embodiment of the present invention.

As shown in FIG. 7, a first auxiliary wing 500-1 can be controlled by a first actuator 520-1 connected to a first base shaft 510-1 and a second auxiliary wing 500-2 can be controlled by a second actuator 520-2 connected to a second base shaft 510-2. The current position of the first auxiliary wing 500-1 is sensed by a first sensing unit 900-1 and the first actuator 520-1 is driven with a driving value outputted from a first driving value creating unit 830-1 in accordance with a comparing result by a first comparing unit 820-1, so the angle of the first auxiliary wing 500-1 can be controlled. The angle of the second auxiliary wing 500-2 can also be controlled in the same way as the first auxiliary wing 500-1.

Referring to FIG. 7, it is possible to control the amount of the air stream flowing down through the holes 410 from the propeller by changing the open areas of the holes 410 by controlling the angles of the first auxiliary wing 500-1 and the second auxiliary wing 500-2 with the first actuator 520-1 and the second actuator 500-2 of the drone that is landing. Accordingly, in deep stall in which the drone cannot controlled due to stall, it is possible to control the balance of the drone by controlling the angles of the first auxiliary wing 500-1 and the second auxiliary wing 500-2 without a specific swashing unit for controlling the blades 110 of the drone.

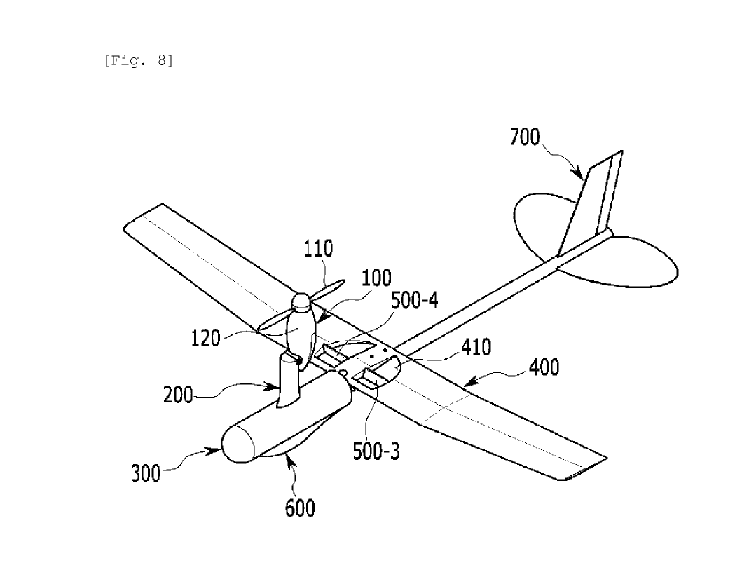

FIG. 8 shows a drone with small-sized auxiliary wings according to an embodiment of the present invention.

FIG. 8 shows small-sized auxiliary wings that can be applied to a drone without an influence on lift, in which although auxiliary wings 500-3 and 500-4 are installed at portions of the holes 410 of the main wing, it is possible to offset anti-torque or control the direction angle and the yaw axis of the drone by controlling the angles of the auxiliary wings with separate actuators, as described with reference to FIG. 7. The auxiliary wings 500-3 and 500-4 can be formed in any shape, as long as they can be inserted in the holes.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. An easy landing drone comprising:
a propeller changing direction;
a propeller tower supporting the propeller;
a body connected to the propeller tower;
a main wing arranged left-right symmetrically with respect to a horizontal axis of the body and having a pair of holes around a center of gravity of the body;
a pair of auxiliary wings disposed in the pair of holes, respectively; and
an actuator connected to a base shaft fixed to the main wing through the pair of auxiliary wings and controlling angles of the pair of auxiliary wings,
wherein the actuator includes a first actuator and a second actuator,
the pair of auxiliary wings includes a first auxiliary wing and a second auxiliary wing,
an angle of the first auxiliary wing is controlled by the first actuator,
an angle of the second auxiliary wing is controlled by the second actuator, and
the propeller looks forward in flight and looks upward in landing.

2. The drone of claim 1, wherein the propeller includes a plurality of blades converting engine torque into thrust, a housing combined with the blades, and a turning neck connecting the housing and the propeller tower to each other, and
the thrust is 40 to 60% of weight of the drone.

3. The drone of claim 2, wherein in the propeller, the blades and the housing look forward when the drone is flying, and the blades and the housing are turned upward by the turning neck when the drone is landing.

4. The drone of claim 2, wherein the turning neck includes one or more of a gear box, a servo motor, and a step motor.

5. The drone of claim 1, further comprising:
a receiving unit receiving a flight control signal including an instruction to control the auxiliary wings;
a sensing unit sensing current positions of the auxiliary wings;
a comparing unit comparing a current position value of the auxiliary wings with a control instruction value of the flight control signal;
a driving value creating unit creating an output value for driving the actuator in accordance with a result of the comparing; and
a driving unit driving the actuator in accordance with the output value.
